(19) United States
(12) Patent Application Publication
(10) Pub. No.: US 2016/0303526 A1
(43) Pub. Date: Oct. 20, 2016

(54) METHOD FOR PREPARING A TRAFFICABLE TAILINGS DEPOSIT

(71) Applicant: SYNCRUDE CANADA LTD. in trust for the owners of the Syncrude Project as such owners exist now and, Fort McMurray (CA)

(72) Inventors: SIMON YUAN, Edmonton (CA); JAMES LORENTZ, Fort McMurray (CA); RANDY MIKULA, Edmonton (CA)

(21) Appl. No.: 14/686,195

(22) Filed: Apr. 14, 2015

(51) Int. Cl. B01F 3/12; B01F 15/02; B01F 7/00

(52) U.S. Cl. CPC B01F 3/1271; B01F 3/1214; B01F 3/1221; B01F 7/00; B01F 15/0235; B01F 15/0229

(57) ABSTRACT

A process for preparing engineered tailings that are essentially immediately trafficable is provided comprising providing a source of high density sand; mixing a source of tailings with the high density sand to give a tailings product having at least about 80 wt % solids and a solids to fines ratio of greater than 2.0; and optionally adding at least one additive to the tailings product if additional strength is required.

### FIELD OF THE INVENTION

The present invention relates generally to a process for preparing a trafficable tailings deposit for reclamation. More particularly, a process is provided for producing engineered tailings (ET) which are substantially immediately trafficable. The invention is particularly useful with, but not limited to, fluid fine tailings (FFT) produced during oil sands extraction processes.

### BACKGROUND OF THE INVENTION

Oil sand generally comprises water-wet sand grains held together by a matrix of viscous heavy oil or bitumen. Bitumen is a complex and viscous mixture of large or heavy hydrocarbon molecules which contain a significant amount of sulfur, nitrogen and oxygen. The extraction of bitumen from sand using hot water processes yields large volumes of tailings composed of fine silts, clays and residual bitumen which have to be contained in a tailings pond. Mineral fractions with a particle diameter less than 44 microns are referred to as “fines.” These fines are typically quartz and clay mineral suspensions, predominantly kaolinite and Mite.

The fine tailings suspension is typically 85 wt % water and 15 wt % fine particles by volume. Dewatering of fine tailings occurs very slowly. When first discharged in the pond, the very low density material is referred to as thin fine tailings. After a few years when the fine tailings have reached a solids content of about 30-35 wt %, they are sometimes referred to as mature fine tailings (MFT). Hereinafter, the more general term of fluid fine tailings (FFT) which encompasses the spectrum of tailings from discharge to final settled state. The FFT behave as a fluid colloidal-like material. The fact that FFT behave as a fluid and have very slow consolidation rates limits options to reclaim tailings ponds. A challenge facing the industry remains the removal of water from the FFT to increase the solids content well beyond 35 wt % and strengthen the deposits to the point that they can be reclaimed and no longer require containment.

The formation of composite/consolidated tailings (CT) is one method used in the oil sands industry to aid in the consolidation of FFT. CT consists of FFT combined with sand generated from hydrocycloning coarse tailings produced during oil sands extraction processes. However, hydrocyclone underflow generally still comprises about 25 to 35 wt % water and, thus, if just mixing the FFT and cyclone underflow, the mixture is not immediately trafficable and is also segregating, i.e., the fines tend to separate away from the sand. Hence, gypsum is added to make the tailings non-segregating and the non-segregating composite tailings are then deposited in a mined-out area. The mixture of FFT, cyclone underflow and gypsum causes the tailings to settle more quickly and release water. CT is then capped with sand and soil, enabling the development of landscapes that support grass, trees and wetlands.

The current CT production is an integrated process downstream of bitumen extraction. The tailings from the bitumen extraction process are the source of the sand component in the CT recipe, so any variations in the extraction feed or operation can significantly impact CT production. Similarly, FFT from the tailings pond is used for the fines component of the CT recipe, and the variability in water and fines content of that stream also impacts the quality of the deposit and the time required before it can be reclaimed.

Typically CT recipes rely on fine tailings from a pond or thickener and a sand tailings source from cyclone underflow of extraction plant tailings. Additives are used to maintain the integrity of the sand and fines mixture while settling and consolidation occurs. However, controlling the process is difficult due to variability in the FFT component (from the tailings pond or thickener), and the sand component which varies with the upstream extraction plant operation. The resulting mixture is deposited either subaerially along a beach or subaqueously.

The fluid nature of the CT means that the depositional velocity has to be carefully controlled in order to prevent shear forces from separating or segregating the sand and fines components again. The higher the water content in either the sand or FFT components, the more difficult it is to prevent segregation, and the longer the material has to be contained as a fluid. The CT fluid will eventually consolidate to about 78-82 wt % solids at which time it can be capped and reclaimed. However, CT consolidation still takes a considerable period of deposit consolidation for water release, during which time the material must be contained as a fluid. Generally, CT must be stored for at least about 3 months and may take up to several years to consolidate enough for capping to occur. Furthermore, CT may become segregating again during the long containment periods, thereby allowing the release of the fines/clays into the water phase again.

Accordingly, there is a need for an improved process for preparing substantially immediately trafficable tailings for reclamation which does not require a fluid containment period.

### SUMMARY OF THE INVENTION

The present invention relates generally to a process for preparing a trafficable tailings deposit for reclamation. The invention is particularly useful with, but not limited to, FFT.

It was surprisingly discovered that by using the process of the present invention, one or more of the following benefits may be realized:

(1) An immediately trafficable deposit, hereinafter referred to as “engineered tailings” or “ET”, is formed.

(2) The ET process of the present invention is decoupled from the bitumen extraction process to minimize variability and, instead, use dewatered sources of sand.

(3) The use of dewatered sand eliminates the need for fluid containment, as is the case with conventional CT, and the ET produced are non-segregating and can be capped and reclaimed almost immediately.

(4) The ET may be formed in situ by mixing and spiking the FFT (and, optionally, additive(s)) directly into a sand layer, for example, a sand layer found within a tailings pond; or by mixing and spiking sand (and, optionally, additive(s)) directly into a FFT layer within a tailings pond.

(5) Compared to conventional CT production, the present invention provides more rapid reclamation of disturbed areas and more reliable and robust tailings disposal in mining operations.

(6) The assembly of components useful in the implementation of the present invention are compact and relocatable. The components may be mobile by being mounted on driven tracks, or may be adapted for easy disassembly for periodic moving and reassembly.

Thus, broadly stated, in one aspect of the present invention, a process for preparing engineered tailings that are substantially immediately trafficable is provided, comprising:
providing a source of high density sand;
mixing a source of tailings with the high density sand to give a tailings product having at least about 80 wt % solids and a solids to fines ratio of greater than about 2.0; and
optionally adding at least one additive to the tailings product if additional strength is required.

In one aspect, the high density sand and the tailings are mixed in a mixer such as a rotary mixer and the tailings product is subsequently deposited in a deposition site. In another aspect, the source of tailings is dense fluid fine tailings present in an oil sands tailings pond and the high density sand is added to the tailings in situ. In one embodiment, the high density sand is added to the tailings in situ and mixed with a soil mixer such as an auger or rototiller mixer.

In another aspect, the tailings are mixed with the high density sand in situ by injecting the tailings into a high density sand deposit and mixing the tailings and sand with a mixer such as an auger or a rototiller mixer. In one embodiment, the high density sand is beach sand.

As used herein, “high density sand” means sand that has been sufficiently dewatered so that when combined with a particular source of tailings it will provide a tailings product having at least about 80 wt % solids and a solids to fines ratio of greater than about 2.0. Typically, high density sand has been dewatered to yield sand having a solids content of about 80 to about 100 wt % solids. In one embodiment, the high density sand has less than about 15 wt % fines. In one embodiment, the source of high density sand can be beach sand, sand dumps, and sand dewatered in sand stacking cyclones, filters, screens, sand screws and the like.

As used herein, “immediately trafficable” means that the tailings deposit has a bearing pressure of about 2 psi or greater.

The source of tailings can be fluid fine tailings or dewatered tailings such as pond bottom tailings (dense fluid fine tailings), thickened tailings, centrifuged tailings, filtered tailings and the like. Dense fluid fine tailings from tailings ponds typically comprise about 20 wt % solids to about 60 wt % solids. Centrifuged tailings (i.e., centrifuge cake) typically comprise about 55 wt % solids or greater, thickened tailings typically comprise about 40 wt % solids or greater and filtered tailings about 65 wt % solids or greater.

In another aspect, a process line for preparing an immediately trafficable tailings deposit is provided, comprising:

a) a hopper or a tailings pond for retaining sand;

b) optionally, removing and transporting means for the sand;

c) optionally, a retainer for retaining a source of tailings;

d) optionally, removing and transporting means for the tailings;

e) a mixer for combining the tailings, the sand, and, optionally, an additive, to form an immediately trafficable tailings deposit; and

f) optionally, removing and transporting means for the mixture.

As used herein “an additive” means a chemical such as a coagulant or flocculant that aids in the strength development of the ET. In one embodiment, the additive is selected from the group gypsum, sulphuric acid, calcium hydroxide, calcium oxide, calcium chloride, sodium aluminate, sodium sulphate, magnesium sulphate, Portland cement, alum, carbon dioxide, magnesium chloride, aluminum chloride, sodium chloride, sodium hydroxide, gypsum+calcium hydroxide, Percol 727™+gypsum, fly ash, Percol 727™, AlcoFlood 1175A™, Aclar W37™, Percol 368™, Alcoflood 1175A™+gypsum, Alclar W37™+gypsum, Percol 155™+gypsum, and combinations thereof.

Thus, use of the present invention yields a tailings deposit which becomes trafficable soon after preparation and enables reclamation of tailings disposal areas.

Additional aspects and advantages of the present invention will be apparent in view of the description, which follows. It should be understood, however, that the detailed description and the specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The invention will now be described by way of an exemplary embodiment with reference to the accompanying simplified, diagrammatic, not-to-scale drawings:

FIG. 1 is a schematic diagram of an embodiment of the present invention for producing engineered tailings (ET) that are essentially immediately trafficable.

FIG. 2 is a schematic diagram of an embodiment of the present invention for producing engineered tailings (ET) that are essentially immediately trafficable.

FIG. 3 is a schematic diagram of an embodiment of the present invention for producing engineered tailings (ET) that are essentially immediately trafficable.

FIG. 4 is a schematic diagram of an embodiment of the present invention for producing engineered tailings (ET) that are essentially immediately trafficable.

FIG. 5 is a schematic diagram of an embodiment of the present invention for producing engineered tailings (ET) that are essentially immediately trafficable.

### DETAILED DESCRIPTION OF PREFERRED EMBODIMENTS

The detailed description set forth below in connection with the appended drawings is intended as a description of various embodiments of the present invention and is not intended to represent the only embodiments contemplated by the inventor. The detailed description includes specific details for the purpose of providing a comprehensive understanding of the present invention. However, it will be apparent to those skilled in the art that the present invention may be practised without these specific details.

Conventional CT production is an integrated process downstream of bitumen extraction, and uses tailings from the extraction process as the source of FFT and sand for the CT/NST recipe; thus, any variations in the extraction process impact CT production. The purpose of CT production is to consume MFT and FFT to create a land surface reclaimable to upland or wetland vegetation. The theory behind CT is to intersperse fines in a sand matrix. Thus, sand is the continuous phase or skeleton and the fines are dispersed throughout the sand matrix. CT starts as a slurry and ends as a semi-solid, loose, silty sand deposit that is dense enough and strong enough to support hydraulic sand capping.

In contrast, the present invention is directed to producing engineered tailings (ET) which decouples its production from the bitumen extraction process to minimize variability by using dewatered sources of sand with a source of tailings. Use of dewatered sand (also referred to as high density sand) eliminates the need for fluid containment during the consolidation process to produce an immediately trafficable deposit which can be capped and reclaimed.

As used herein, the term “tailings” means tailings from a mining operation and the like that contain a fines fraction. As used herein, “oil sands tailings” mean tailings derived from an oil sands extraction process and include fluid fine tailings (FFT) from tailings ponds and fine tailings from ongoing extraction operations (for example, flotation tailings, thickener underflow or froth treatment tailings) which may or may not bypass a tailings pond. In one embodiment, FFT useful in the present invention is centrifuged FFT, in-situ FFT (pond bottoms), dewatered rim ditch FFT, thickened FFT, or FFT that has not been dewatered.

As used herein, the term “sand” refers to mineral solids with a particle size greater than about 44 μm. The dewatered sand may be sourced from beaches, sand dumps, sand stacking cyclones, filters, screens, sand screws, and the like.

As used herein, the term “sand to fines ratio (SFR)” is defined as the mass ratio of sand to fines, i.e., the mass of mineral solids with particle size >44 μm divided by the mass of mineral solids with particle size ≦44 μm.

For use in the present invention, the sand has been previously dewatered. Dewatering is commonly known to those skilled in the art and will not be discussed in detail. Common dewatering methods involve thickeners, centrifugation, filtration, freeze-thaw, desiccation, underdrainage, and the like. As used herein, the term “dewatered FFT” refers to FFT which has been dewatered to yield tailings having a solids content of greater than about 20 wt %.

In particular embodiments described herein, engineered tailings may be produced using a process line or an assembly of components which are compact and relocatable. The components may be mobile, for example by being mounted on driven tracks, or they may be adapted for easy disassembly for periodic moving and reassembly. The term “relocatable” is intended to describe both versions. Particular embodiments may also include the arrangement of downwardly sequenced components which rely on gravity feed.

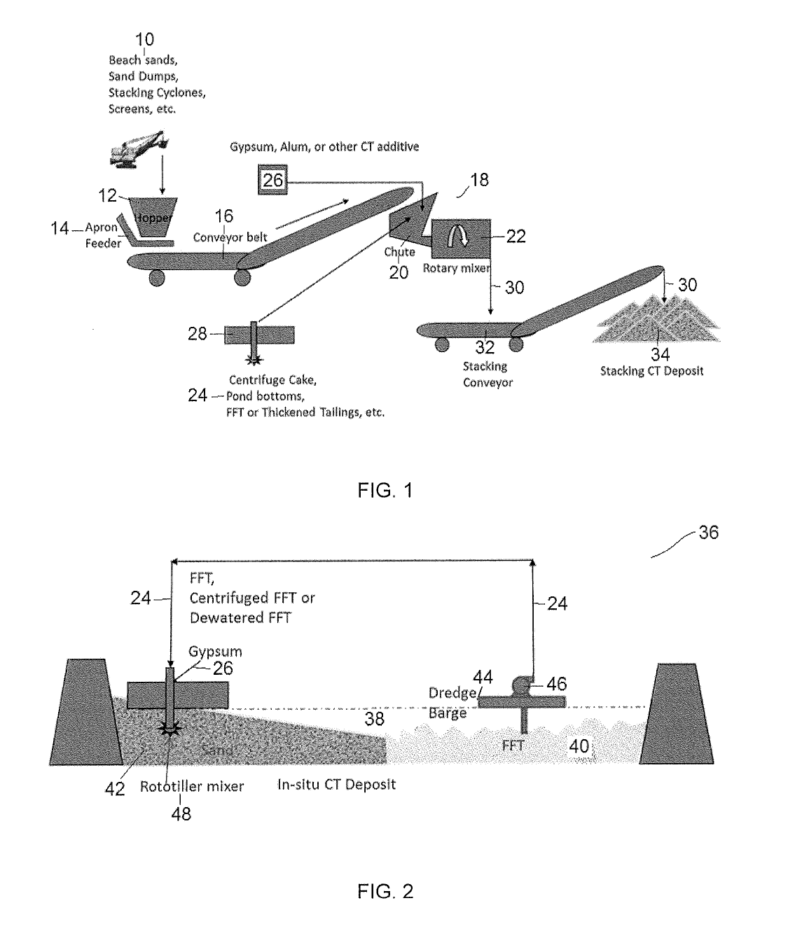

Turning to the specific embodiment shown in FIG. 1, high density (dewatered) sand 10 is dumped into a hopper 12 and is removed from the hopper 12 by a bottom apron feeder 14 at a desired controlled, sustained mass flow rate. The apron feeder 14 transfers the high density sand 10 from the hopper 12 to a lift belt conveyor 16. The operation of conveyors is commonly known to those skilled in the art and will not be discussed in detail. Briefly, a conveyor is formed of individual apron plates that are linked together with hinges on its underside, thus creating a looped carrying surface on which materials can be placed and moved from one location to another.

The lift belt conveyor 16 is upwardly inclined, and transports and feeds the high density sand 10 from an elevated discharge point to a slurry preparation unit 18 comprising a chute 20 positioned above a mixer 22. In one embodiment, the mixer 22 is a rotary mixer. It is understood by a person skilled in the art that any soil mixer known in the art can be used, provided thorough mixing of the sand and tailings is achieved, i.e., homogeneous mixing is achieved. In one embodiment, the mixer comprises a multi-stage conveyor belt system comprising a number of cascading conveyor belts that can be used to ensure proper and thorough mixing of the sand and tailings.

The high density sand 10 flows from the chute 20 into the mixer 22. Tailings 24, which may or may not be dewatered and an additive 26 are added to the high density sand 10 being fed from the lift belt conveyor 16 to the chute 20. In one embodiment, the tailings 24 may be transferred from a rototiller mixer 28 to the chute 20. In one embodiment, a preferred additive or mixture of additives may be selected according to the desired ET recipe. Suitable additives include, but are not limited to, gypsum, alum, and the like.

The high density sand 10, tailings 24, and additive 26 combine in the mixer 22 and form product tailings (ET) 30, as they proceed downwardly to drop from the mixer 22 onto a stacking lift belt conveyor 32. The stacking lift belt conveyor 32 is upwardly inclined, and transports and delivers the product tailings (ET) 30 from an elevated discharge point to an appropriate area. The product tailings (ET) 30 are stacked to form ET deposit 34.

In one embodiment, the ET deposit comprises about 83 wt % solids and about 18 wt % fines (SFR of about 4.55). This ET deposit is formed by combining about 4 portions of sand having about 90 wt % solids and about 7 wt % fines, and about 1.5 portions of dewatered FFT having about 55 wt % solids and about 90 wt % fines. In one embodiment, the sand is beach sand. In one embodiment, the beach sand has a fines content of between about 5 wt % to about 15 wt % (SFR of about 19.0 to about 5.7). In one embodiment, the dewatered FFT is centrifuge cake.

In one embodiment, the ET deposit comprises 83 wt % solids and about 11 wt % fines (SFR of about 7.85). This ET deposit is formed by combining about 4 portions of sand having about 90 wt % solids and about 7 wt % fines, and 1 portion of FFT having about 35 wt % solids and about 90 wt % fines. In one embodiment, the sand is beach sand. In one embodiment, the beach sand has a fines content of between about 5 to about 15% (SFR of about 19.0 to about 5.7).

The hopper 12, apron feeder 14, and lift belt conveyor 16 may be mounted on a common structural frame. Similarly, the stacking lift belt conveyor 32 and slurry preparation unit 18 (including the chute 20 and mixer 22) may be mounted on a common structural frame. The frames may be preferably mounted for example, on tracks, so that the entire assembly may periodically be advanced to a new location.

Turning to the specific embodiment shown in FIG. 2, tailings 24 is obtained from a tailings pond 36. Tailings stream(s) produced from bitumen extraction is typically transferred to a tailings pond 36 where the tailings stream(s) separates into an upper water layer 38, a middle fluid fine tailings layer 40, and a bottom layer of settled solids or sand 42. In FIG. 2, the middle FFT layer 40 and bottom sand layer 42 are shown side-by-side to illustrate only for clarity. The bottom sand layer 38 is sufficiently dewatered to provide a source of high density sand. The FFT layer 40, which generally comprises about 35 wt % solids and about 90 wt % fines, is removed from between the water layer 38 and bottom sand layer 42 via a dredge or floating barge 44 having a submersible pump 46. The tailings 24 (removed FFT from FFT layer 40) and additive 26 (for example, gypsum) are mixed and spiked into the sand layer 42 using an auger or rototiller mixer 48 to form an in-situ ET deposit directly within the tailings pond 36.

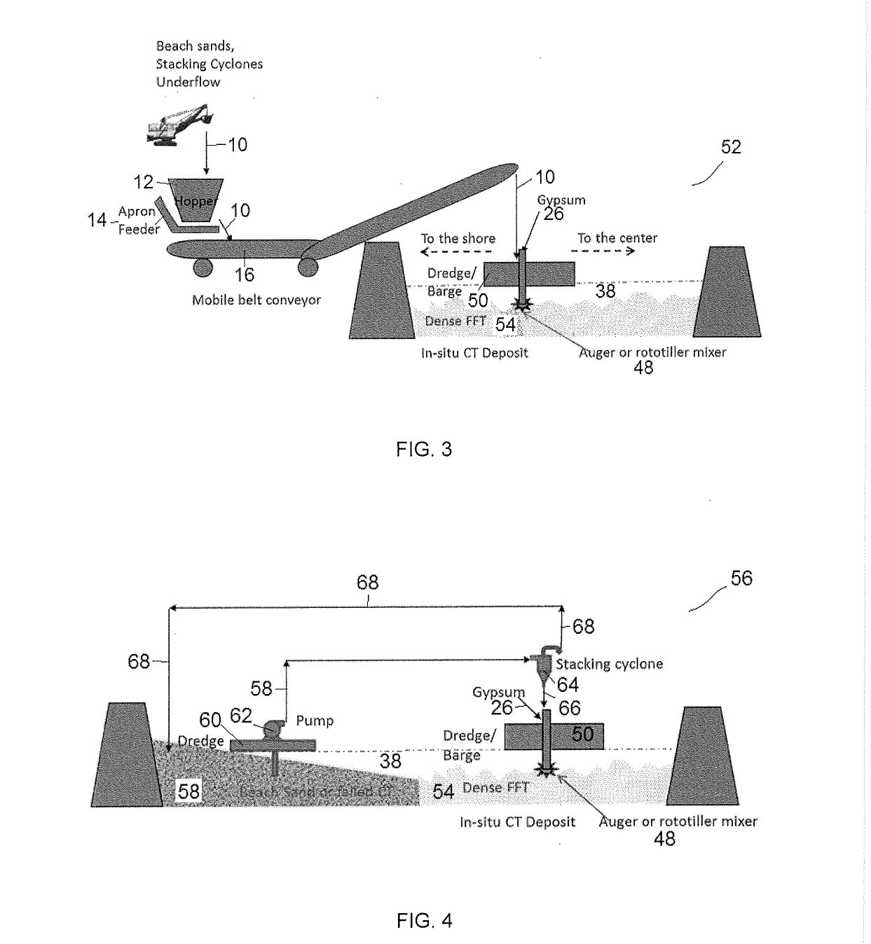

Turning to the specific embodiment shown in FIG. 3, high density (dewatered) sand 10 is dumped into a hopper 12 and is removed from the hopper 12 by a bottom apron feeder 14 at a desired controlled, sustained mass flow rate. The apron feeder 14 transfers the sand 10 from the hopper 12 to a lift belt conveyor 16. The lift belt conveyor 16 is upwardly inclined, and transports and feeds the high density sand 10 to an auger or rototiller mixer 48. The auger or rototiller mixer 48 is carried by a dredge or floating barge 50 positioned within a tailings pond 52. The pond 52 is formed of an upper water layer 38 and a bottom, dewatered dense FFT layer 54. In one embodiment, the dense FFT layer 54 comprises a solids content of greater than about 40 wt %, with the fines content ranging between about 80 wt % to about 100 wt % (SFR ranging between about 0.25 to about 0).

The dredge or floating barge 50 within the pond 52 can be moved for example, from the center to the shore and vice versa to enable proper positioning of the auger or rototiller mixer 48 below the lift belt conveyor 16, thereby ensuring that the high density sand 10 is dropped directly from the lift belt conveyor 16 into the auger or rototiller mixer 48 rather than into the water layer 38. Further facilitating this positioning, the hopper 12, apron feeder 14, and lift belt conveyor 16 are mounted on a common structural frame which may be preferably mounted for example, on tracks, so that the entire assembly is mobile and can be moved towards the pond 52.

The high density sand 10 and additive 26 (for example, gypsum) are mixed and spiked using an auger or rototiller mixer 48 into the dense FFT layer 54 to form an in-situ ET deposit directly within the pond 52.

Turning to the specific embodiment shown in FIG. 4, a tailings pond 56 is shown formed of an upper water layer 38, a dewatered dense FFT layer 54, and a layer of beach sand or failed or segregated subaqueous CT deposit 58, both of which are pumpable. A dredge 60 having a submersible pump 62 is positioned within the layer of beach sand or failed CT deposit 58.

The beach sand or failed CT deposit 58 is pumped, transported and fed to a stacking cyclone 64 for dewatering to yield an underflow stream of sand 66 and an over-flow stream of water 68. In one embodiment, the underflow stream of dewatered sand 66 is further screened to provide high density sand comprises a solids content ranging between about 80 wt % to about 95 wt %.

The stacking cyclone 64 and, optionally, a screen or any dewatering equipment such as an inclined spiral classifier that allows water to immediately release from the stacking sand (not shown) is positioned over an auger or rototiller mixer 48. The auger or rototiller mixer 48 is carried by a dredge or floating barge 50, and is positioned within the dense FFT layer 54. In one embodiment, the dense FFT layer 54 comprises a solids content of greater than about 40 wt %, with the fines content ranging between about 80 wt % to about 100 wt % (SFR ranging between about 0.25 to about 0).

The underflow stream of dewatered sand 66 and an additive 26 (for example, gypsum) are mixed and spiked into the dense FFT layer 54 using an auger or rototiller mixer 48 to form an in-situ CT deposit directly within the pond 56. The overflow stream of water 68 is recycled back into the water layer 38.

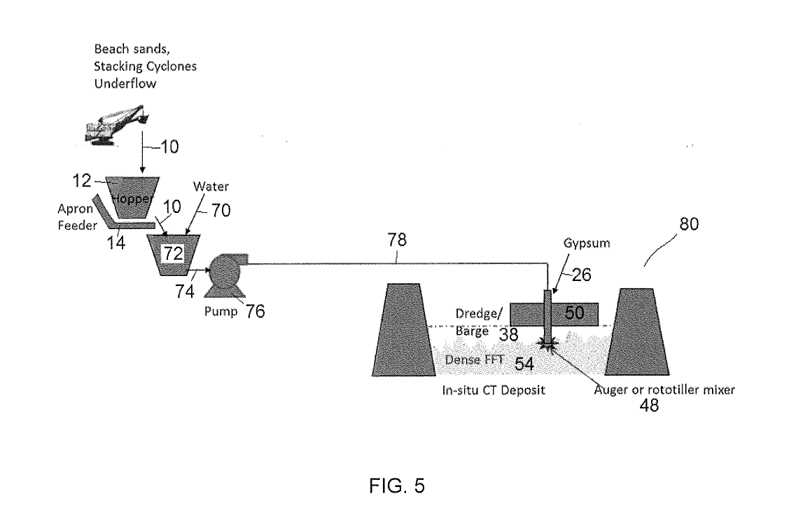

Turning to the specific embodiment shown in FIG. 5, dewatered sand 10 is dumped into a hopper 12 and is removed from the hopper 12 by a bottom apron feeder 14 at a desired controlled, sustained mass flow rate. The sand 10 is slurried with water 70 as it is transferred from the apron feeder 14 into a suitable vessel 72. The slurry 74 is pumped via pump 76 into line 78.

The slurry 74 is introduced into an auger or rototiller mixer 48. The auger or rototiller mixer 48 is carried by a dredge or floating barge 50 positioned within a tailings pond 80. The pond 80 is formed of an upper water layer 38 and a bottom, dewatered dense FFT layer 54. In one embodiment, the dense FFT layer 54 comprises a solids content of greater than about 40 wt %, and a fines content ranging between about 80 wt % to about 100 wt % (SFR ranging between about 0.25 to about 0).

The slurry 74 and additive 26 (for example, gypsum) are mixed and spiked into the dense FFT layer 54 using the auger or rototiller mixer 48 to form an in-situ CT deposit directly within the pond 80.

From the foregoing description, one skilled in the art, can easily ascertain the essential characteristics of this invention, and without departing from the spirit and scope thereof, can make various changes and modifications of the invention to adapt it to various usages and conditions. Thus, the present invention is not intended to be limited to the embodiments shown herein, but is to be accorded the full scope consistent with the claims, wherein reference to an element in the singular, such as by use of the article “a” or “an” is not intended to mean “one and only one” unless specifically so stated, but rather “one or more”. All structural and functional equivalents to the elements of the various embodiments described throughout the disclosure that are known or later come to be known to those of ordinary skill in the art are intended to be encompassed by the elements of the claims. Moreover, nothing disclosed herein is intended to be dedicated to the public regardless of whether such disclosure is explicitly recited in the claims.

1. A process for preparing engineered tailings that are essentially immediately trafficable, comprising:
(a) providing a source of high density sand;
(b) mixing a source of tailings with the high density sand to give a tailings product having at least about 80 wt % solids and a solids to fines ratio of greater than about 2.0; and
(c) optionally adding at least one additive to the tailings product if additional strength is required.

2. The process as claimed in claim 1, wherein the high density sand and the tailings are mixed in a sand mixer such as a rotary mixer and the tailings product is subsequently deposited in a deposition site,

3. The process as claimed in claim 1, wherein the source of tailings is dense fluid fine tailings present in an oil sands tailings pond and the high density sand is added to the tailings in situ.

4. The process as claimed in claim 3, wherein the high density sand is added to the tailings in situ and mixed with a mixer such as an auger or rototiller mixer.

5. The process as claimed in claim 1, wherein the tailings are mixed with the high density sand in situ by injecting the tailings into a high density sand deposit and mixing the tailings and sand with a mixer such as a rototiller mixer.

6. The process as claimed in claim 1, wherein the high density sand is beach sand.

7. The process as claimed in claim 1, wherein the high density sand has been sufficiently dewatered so that when combined with a particular source of tailings it will provide a tailings product having at least about 80 wt % solids and a solids to fines ratio of greater than 4.0.

8. The process as claimed in claim 7, wherein the high density sand has been dewatered to yield sand having a solids content of about 80 to about 95 wt % solids

9. The process as claimed in claim 1, wherein the high density sand is beach sand, sand dumps, or sand dewatered in sand stacking cyclones, filters, screens, sand screws and the like.

10. The process as claimed in claim 1, wherein the source of tailings can be oil sands tailings selected from the group fluid fine tailings, dewatered tailings such as pond bottom tailings, thickened tailings, centrifuged tailings, filtered tailings and the like.

11. The process as claimed in claim 1, wherein the additive is selected from the group gypsum, sulphuric acid, calcium hydroxide, calcium oxide, calcium chloride, sodium aluminate, sodium sulphate, magnesium sulphate, Portland cement, alum, carbon dioxide, magnesium chloride, aluminum chloride, sodium chloride, sodium hydroxide, gypsum+calcium hydroxide, Percol 727™+gypsum, fly ash, Percol 727™, AlcoFlood 1175A™, Aclar W37™, Percol 368™, Alcoflood 1175A™+gypsum, Alclar W37™+gypsum, Percol 155™+gypsum, and combinations thereof.

12. A process line for preparing an immediately trafficable tailings deposit comprising:
a) a hopper or a tailings pond for retaining sand;
b) optionally, removing and transporting means for the sand;
c) optionally, a retainer for retaining a source of tailings;
d) optionally, removing and transporting means for the tailings;
e) a mixer for combining the tailings, the sand, and, optionally, an additive, to form immediately trafficable tailings; and
f) optionally, removing and transporting means for the immediately trafficable tailings.

13. The process line of claim 12, wherein the additive is selected from gypsum or alum.

14. The process line of claim 13, comprising the hopper and components (b), (e), and (f).

15. The process line of claim 14, wherein component (b) comprises an apron feeder for transferring the sand from the hopper to a first belt conveyor.

16. The process line of claim 15, wherein the first belt conveyor is upwardly inclined to transport and feed the sand from an elevated discharge point into a slurry preparation unit to mix with the tailings and the additive to yield a slurry.

17. The process of claim 16, further comprising a second belt conveyor which is upwardly inclined to transport and deposit the slurry from an elevated discharge point onto a site to stack the immediately trafficable tailings.

18. The process line of claim 17, wherein the immediately trafficable tailings comprises about 83 wt % solids and about 18 wt % fines.

19. The process line of claim 18, wherein the immediately trafficable tailings is formed by combining about 4 portions of sand having about 90 wt % solids and about 7 wt % fines, and about 1.5 portions of FFT having about 55 wt % solids and about 90 wt % fines.

20. The process line of claim 17, wherein the immediately trafficable tailings comprises about 83 wt % solids and about 11 wt % fines.

21. The process line of claim 20, wherein the immediately trafficable tailings is formed by combining about 4 portions of sand having about 90 wt % solids and about 7 wt % fines, and 1 portion of FFT having about 35 wt % solids and about 90 wt % fines.

22. The process line of claim 17, wherein the hopper, the apron feeder, and the first belt conveyor are mounted on a first relocatable common structural frame, and the second belt conveyor and the slurry preparation unit are mounted on a second relocatable common structural frame.

23. The process line of claim 13, comprising the tailings pond and components (c), (d), and (e), wherein the tailings pond has a water layer, a FFT layer, and a sand layer.

24. The process line of claim 23, further comprising a dredge-pump assembly submerged in the FFT layer for pumping the FFT to an auger or a rototiller mixer positioned in the sand layer.

25. The process line of claim 24, wherein the FFT and the additive are mixed into the sand layer to yield the immediately trafficable tailings in situ.

26. The process line of claim 13, comprising the hopper and components (b), (c), and (e).

27. The process line of claim 26, wherein component (b) comprises an apron feeder for transferring the sand from the hopper to a belt conveyor.

28. The process line of claim 27, wherein the belt conveyor is upwardly inclined to transport and feed the sand from an elevated discharge point into the mixer.

29. The process line of claim 18, wherein the mixer is selected from an auger or a rototiller mixer moveable on a dredge positioned within a tailings pond having a FFT layer.

30. The process line of claim 29, wherein the FFT layer comprises a solids content of greater than about 40 wt %, and a fines content ranging between about 80 wt % to about 100 wt %.

31. The process line of claim 29, wherein the sand and the additive are mixed into the FFT layer to yield the immediately trafficable tailings in situ.

32. The process line of claim 31, wherein the hopper, the apron feeder, and the belt conveyor are mounted on a relocatable common structural frame.

33. The process line of claim 26, wherein component (b) comprises an apron feeder for transferring the sand from the hopper to a vessel, the sand being slurried with water during transfer to yield a slurry,

34. The process line of claim 33, further comprising a pump for pumping the slurry to an auger or rototiller mixer carried by a dredge positioned within a tailings pond having a water layer and a FFT layer.

35. The process line of claim 34, wherein the FFT layer comprises a solids content of greater than about 40 wt %, and a fines content ranging between about 80 wt % to about 100 wt %.

36. The process line of claim 34, wherein the slurry and the additive are mixed into the FFT layer to yield the immediately trafficable tailings in situ.

37. The process line of claim 13, comprising the tailings pond and components (b), (c), and (e), wherein the tailings pond has a water layer, a FFT layer, and a sand layer.

38. The process line of claim 37, wherein the sand layer comprises beach sand or a failed/segregated subaqueous CT deposit.

39. The process line of claim 38, further comprising a dredge-pump assembly submerged within the sand layer for transporting and feeding the sand to a stacking cyclone positioned over an auger or rototiller mixer carried by a dredge positioned within the FFT layer.

40. The process line of claim 39, wherein the FFT layer comprises a solids content of greater than about 40 wt %, and a fines content ranging between about 80 wt % to about 100 wt %.

41. The process of claim 39, wherein the stacking cyclone dewaters the sand layer to yield an underflow stream of dewatered sand and an overflow stream of water.

42. The process line of claim 41, wherein the underflow stream of dewatered sand and the additive are mixed into the FFT layer to yield the immediately trafficable tailings in situ.

43. The process line of claim 41, wherein the overflow stream of water is recycled back into the water layer.
